(19) United States
(12) Patent Application Publication
(10) Pub. No.: US 2026/0361088 A1
(43) Pub. Date: Nov. 12, 2026

(54) POWER SUPPLY CIRCUIT AND ENERGY STORAGE POWER SUPPLY

(71) Applicant: SHENZHEN HELLO TECH ENERGY CO., LTD, Shenzhen (CN)

(72) Inventors: Gaosong SHEN, Shenzhen (CN); Feiyan LUO, Shenzhen (CN)

(21) Appl. No.: 19/726,895

(22) Filed: Jun. 30, 2026

(30) Foreign Application Priority Data
Mar. 26, 2026 (CN) 202610389652.1

(51) Int. Cl. H02J 3/32

(52) U.S. Cl. CPC H02J 3/32

(57) ABSTRACT

A power supply circuit and an energy storage power supply. An inverter of the power supply circuit includes a first live terminal and a first neutral terminal. A detection module is configured to detect currents flowing through each of a first live branch and a first neutral branch. A grounding unit is configured to electrically connect the first neutral terminal and a first ground terminal of an alternating-current output interface through bypassing the detection module, to support a grounding detection. A first switch element is configured to control connection and disconnection of the first live branch and the first neutral branch. A control module is configured to control, when a total current of the first neutral branch and the first live branch is greater than a predetermined threshold, the first switch element to be switched off and/or the inverter to stop operating.

### CROSS-REFERENCE TO RELATED APPLICATION

This application claims priority to and the benefit of Chinese Patent Application No. 202610389652.1, filed with China National Intellectual Property Administration on Mar. 26, 2026, the entire contents of which are incorporated herein by reference.

### FIELD

The present disclosure relates to the field of energy storage technologies, and specifically, to a power supply circuit and an energy storage power supply.

### BACKGROUND

In the related art, a mobile energy storage power supply or a household energy storage system can convert a direct current output by a battery module into an alternating current through an inverter, and supplies power to an external electrical load through a standard alternating current socket. Currently, when not being grounded, the energy storage power supply does not have a function of providing a grounding signal; when not being connected to a utility power, the energy storage power supply cannot provide the grounding signal to a load that requires a grounding detection, such that the energy storage power supply cannot supply power to the load. To solve such a problem, some users short-circuit a neutral terminal and a ground terminal of an output port through an external socket accessory to bypass the grounding detection. However, supplying power to the load through the external socket accessory poses a risk of electric shock when a current leakage occurs in the load.

### SUMMARY

Embodiments of the present disclosure provide a power supply circuit for an energy storage power supply. The power supply circuit includes: an inverter including a first live terminal and a first neutral terminal; an alternating-current output interface including a second live terminal, a second neutral terminal, and a first ground terminal, in which the alternating-current output interface is configured to be connected to a load; a first live branch, in which the first live terminal and the second live terminal are connected to each other by the first live branch; a first neutral branch, in which the first neutral terminal and the second neutral terminal are connected to each other by the first neutral branch; a detection module configured to detect a current flowing through the first live branch and a current flowing through the first neutral branch; a grounding unit configured to electrically connect the first neutral terminal and the first ground terminal through bypassing the detection module, to support a grounding detection; a first switch element configured to control connection and disconnection of the first live branch and the first neutral branch; and a control module configured to control, when a total current of the first live branch and the first neutral branch is greater than a predetermined threshold, the first switch element to be switched off and/or the inverter to stop operating.

In the above energy storage power supply, the grounding unit can provide a grounding signal to the load, enabling the energy storage power supply to supply power to the load. Detecting that the total current of the first live branch and the first neutral branch is greater than the predetermined threshold indicates that a current leakage occurs in the load. In this case, the control module may control the first switch element to be switched off and/or the inverter to stop operating, avoiding a risk of electric shock.

In some embodiments, the grounding unit includes a second switch element and a current limiter that are connected in series between the first neutral terminal and the first ground terminal. The current limiter is configured to simulate a grounding impedance. The second switch element is configured to: when being switched on, connect the current limiter to t he first neutral terminal and the first ground terminal to support the grounding detection; and when being switched off, disconnect the current limiter from the first neutral terminal and the first ground terminal.

In the above power supply circuit, power can be supplied from the energy storage power supply to the load through passing the grounding detection of the load.

In some embodiments, the power supply circuit further includes further an alternating-current input interface configured to be connected to a utility power. The alternating-current input interface includes a third live terminal, a third neutral terminal, and a second ground terminal. The first live terminal and the third live terminal are connected to each other by a second live branch. The first neutral terminal and the third neutral terminal are connected to each other by a second neutral branch. The first ground terminal and the second ground terminal are connected to each other by a ground branch. The grounding unit is electrically connected to the second neutral branch and the first ground terminal.

In the above power supply circuit, electric energy supply under different operation conditions can be achieved.

In some embodiments, the power supply circuit further includes a third switch element disposed on the second live branch, and a fourth switch element disposed on the second neutral branch. The grounding unit includes a first connection terminal and a second connection terminal. The first connection terminal is connected between the third neutral terminal and the fourth switch element, and the second connection terminal is connected to the second ground terminal, the first ground terminal, or the ground branch.

In the above power supply circuit, by controlling switching-on and switching-off different switch elements, connection and disconnection of different branches are easily achieved.

In some embodiments, the control module is further configured to control, when the alternating-current input interface is disconnected from the utility power and the load requires grounding, each of the first switch element, the second switch element, and the fourth switch element to be switched on and the third switch element to be switched off, enabling electric energy output by the inverter to be transmitted to the load.

In the above power supply circuit, through cooperation of the first switch element, the second switch element, the third switch element, and the fourth switch element, independent power supply from the energy storage power supply to the load is easily achieved.

In some embodiments, the control module is further configured to control, when the alternating-current input interface is connected to the utility power, each of the first switch element, the third switch element, and the fourth switch element to be switched on and the second switch element to be switched off, enabling electric energy from the utility power to be transmitted to the load.

In the above power supply circuit, through the cooperation of the first switch element, the second switch element, the third switch element, and the fourth switch element, supplying power from the utility power to the load through the energy storage power supply is easily achieved.

In some embodiments, the power supply circuit further includes a third switch element disposed on the second live branch and the second neutral branch, and a fourth switch element disposed on the second neutral branch and located between the third switch element and the first neutral terminal. The grounding unit includes a first connection terminal and a second connection terminal. The first connection terminal is connected between the third switch element and the fourth switch element, and the second connection terminal is connected to the second ground terminal, the first ground terminal, or the ground branch.

In the above power supply circuit, by controlling switching-on and switching-off different switch elements, connection and disconnection of different branches are easily achieved.

In some embodiments, the control module is further configured to control, when the alternating-current input interface is disconnected from the utility power and the load requires grounding, each of the first switch element, the second switch element, and the fourth switch element to be switched on and the third switch element to be switched off, enabling electric energy output by the inverter to be transmitted to the load.

In the above power supply circuit, through the cooperation of the first switch element, the second switch element, the third switch element, and the fourth switch element, the independent power supply from the energy storage power supply to the load is easily achieved.

In some embodiments, the control module is further configured to control, when the alternating-current input interface is connected to the utility power, each of the first switch element, the third switch element, and the fourth switch element to be switched on and the second switch element to be switched off, enabling electric energy from the utility power to be transmitted to the load.

In the above power supply circuit, through the cooperation of the first switch element, the second switch element, the third switch element, and the fourth switch element, supplying power from the utility power to the load through the energy storage power supply is easily achieved.

Embodiments of the present disclosure provide an energy storage power supply. The energy storage power supply includes the power supply circuit according to any of the above embodiments and a battery module electrically connected to the inverter.

In the above energy storage power supply, the grounding unit can provide a grounding signal to the load, enabling the energy storage power supply to supply power to the load. Detecting that the total current of the first live branch and the first neutral branch is greater than the predetermined threshold indicates that a current leakage occurs in the load. In this case, the control module may control the first switch element to be switched off and/or the inverter to stop operating, avoiding a risk of electric shock.

Additional aspects and advantages of the embodiments of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a first schematic block diagram of an energy storage power supply according to an embodiment of the present disclosure.

FIG. 2 is a second schematic block diagram of an energy storage power supply according to an embodiment of the present disclosure.

FIG. 3 is a third schematic block diagram of an energy storage power supply according to an embodiment of the present disclosure.

FIG. 4 is a fourth schematic block diagram of an energy storage power supply according to an embodiment of the present disclosure.

Description of reference numerals:
load 200, shell 20;
energy storage power supply 100, power supply circuit 100a, housing 10, alternating-current input interface 32, alternating-current output interface 34, first live branch 41, second live branch 43, first neutral branch 45, second neutral branch 47, ground branch 49, battery module 50, grounding unit 72, current limiter 721, inverter 76, control module 90, detection module 95.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

In the description of the present disclosure, it should be understood that, the orientation or the position indicated by terms such as “center”, “longitudinal”, “transverse”, “length”, “width”, “thickness”, “over”, “below”, “front”, “rear”, “left”, “right”, “vertical”, “horizontal”, “top”, “bottom”, “inner”, “outer”, “clockwise”, and “anti-clockwise” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure. In the description of the present disclosure, “a plurality of” means two or more, unless otherwise specifically defined.

In the description of the present disclosure, it should be noted that, unless otherwise clearly specified and limited, terms such as “install”, “connect”, and “connect to” should be understood in a broad sense. For example, it may be a fixed connection or a detachable connection or connection as one piece; mechanical connection or electrical connection; direct connection or indirect connection through an intermediate; internal communication of two components or the interaction relationship between two components. For those of ordinary skill in the art, the specific meaning of the above-mentioned terms in the present disclosure can be understood according to specific circumstances.

In the present disclosure, unless expressly stipulated and defined otherwise, the first feature “on” or “under” the second feature may mean that the first feature is in direct contact with the second feature, or the first and second features are in indirect contact through another feature between them. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

Various embodiments or examples for implementing different structures of the present disclosure are provided below. In order to simplify the description of the present disclosure, components and arrangements of specific examples are described herein. These specific examples are merely for the purpose of illustration, rather than limiting the present disclosure. Further, the same reference numerals and/or reference letters may appear in different examples of the present disclosure for the purpose of simplicity and clarity, instead of indicating a relationship between different embodiments and/or the discussed arrangements. In addition, the present disclosure provides examples of various specific processes and materials. However, applications of other processes and/or the use of other materials are conceivable for those of ordinary skill in the art.

In the related art, some electrical devices (such as devices with leakage protection, insulation monitoring, or grounding detection functions) require satisfactory grounding between a neutral wire and a ground wire of their power supply to complete a grounding detection or self-check procedures; otherwise, issues such as failure to start, frequent error reporting, or inability to operate will occur. Conventional energy storage power supplies are internally provided with a grounding circuit that can provide a grounding signal to an electrical load during independent power supply without a utility power input, passing the grounding detection and allowing the energy storage power supply to supply power to the electrical load. However, the energy storage power supply does not have a true physical grounding terminal and cannot form an effective grounding loop. Therefore, when the load experiences a line leakage, a risk of electric shock is likely to occur. Accordingly, there is a need for an energy storage power supply that ensures a normal operation of the load and avoids electric shock accidents during the independent power supply without the utility power input.

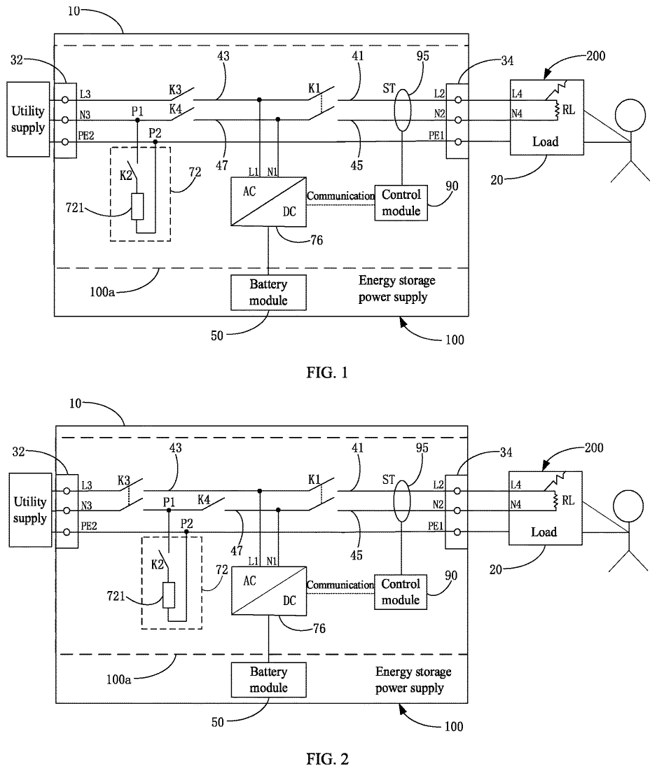

As illustrated in FIG. 1 to FIG. 4, an embodiment of the present disclosure provides a power supply circuit 100a for an energy storage power supply 100. The power supply circuit 100a includes an inverter 76, an alternating-current output interface 34, a first live branch 41, a first neutral branch 45, a detection module 95, a grounding unit 72, a first switch element K1, and a control module 90.

The inverter 76 includes a first live terminal L1 and a first neutral terminal N1. The alternating-current output interface 34 includes a second live terminal L2, a second neutral terminal N2, and a first ground terminal PE1. The alternating-current output interface 34 is configured to be connected to a load 200. The first live terminal L1 and the second live terminal L2 are connected to each other by the first live branch 41. The first neutral terminal N1 and the second neutral terminal N2 are connected to each other by the first neutral branch 45. The detection module 95 is configured to detect a current flowing through the first live branch 41 and a current flowing through the first neutral branch 45. The grounding unit 72 is configured to electrically connect the first neutral terminal N1 and the first ground terminal PE1 through bypassing the detection module 95, to support a grounding detection. The first switch element K1 is configured to control connection and disconnection of the first live branch 41 and the first neutral branch 45.

The control module 90 is configured to control, when it is detected that a total current of the first live branch 41 and the first neutral branch 45 is greater than a predetermined threshold, the first switch element K1 to be switched off and/or the inverter 76 to stop operating.

In the above energy storage power supply 100, the grounding unit 72 can provide the grounding signal to the load 200, enabling the energy storage power supply 100 to supply power to the load 200. Detecting that the total current of the first live branch 41 and the first neutral branch 45 is greater than the predetermined threshold indicates that a current leakage occurs in the load 200. In this case, the control module 90 may control the first switch element K1 to be switched off and/or the inverter 76 to stop operating, avoiding a risk of electric shock.

In an exemplary embodiment of the present disclosure, the alternating-current output interface 34 is disposed on a housing 10 of the energy storage power supply 100 to facilitate a connection with an external device. The alternating-current output interface 34 may be pluggably connected to the load 200 via a cable. In an exemplary embodiment of the present disclosure, the alternating-current output interface 34 may be a male interface or a female interface.

The first switch element K1 is disposed on the first live branch 41 and the first neutral branch 45, and is configured to control conduction and interruption of a current flowing between the inverter 76 and the alternating-current output interface 34. The inverter 76 may be used for a bidirectional conversion between an alternating current and a direct current. As illustrated in FIG. 1 to FIG. 4, the control module 90 is communicatively connected to the inverter 76 to control an operation state of the inverter 76. In an exemplary embodiment of the present disclosure, the energy storage power supply 100 further includes a battery module 50 electrically connected to the inverter 76. In one embodiment, the control module 90 is configured to control, when the utility power input is detected by the energy storage power supply 100 and the battery module 50 needs to be charged, the first switch element K1 to be switched on, and the inverter 76 to convert an alternating current output by the utility power into a direct current suitable for supplying power to the battery module 50. In one embodiment, the control module 90 is further configured to control, when no utility power input is detected by the energy storage power supply 100 and the load 200 needs to be charged, the first switch element K1 to be switched on, and the inverter 76 to convert a direct current output by the battery module 50 into an alternating current suitable for supplying power to the load 200 and output the alternating current to the alternating-current output interface 34, which is then input to the load 200 through a cable to charge the load 200. In an exemplary embodiment of the present disclosure, the first switch element K1 may include a relay.

The detection module 95 is disposed on the first live branch 41 and the first neutral branch 45. The control module 90 is electrically connected to the detection module 95. The detection module 95 may be configured to detect a current of the first live branch 41 and a current of the first neutral branch 45 and feed back the detected currents to the control module 90. The control module 90 may be configured to calculate and obtain the total current of the first live branch 41 and the first neutral branch 45, and determine, based on a comparison between the real-time total current and the predetermined threshold, whether a risk of electric shock exists. In an exemplary embodiment of the present disclosure, the detection module 90 includes a current sensor (ST, Sensor Text).

In an exemplary embodiment of the present disclosure, the load 200 includes a shell 20, a working resistor RL, a fourth live terminal L4, and a fourth neutral terminal N4. When the energy storage power supply 100 is required to supply power to the load 200, a second switch element K2 is in a switching-on state. In one embodiment, in a case where the load 200 requires grounding and no utility power is input, when the load 200 operates normally with no current leakage from a live wire to the shell 20, a current flowing path is sequentially formed by the first live terminal L1, the second live terminal L2, the fourth live terminal L4, the working resistor RL, the fourth neutral terminal N4, the second neutral terminal N2, and the first neutral terminal N1. In this case, since a current of the first live branch 41 and a current of the first neutral branch 45 are equal in magnitude and opposite in direction, the currents cancel each other out, resulting in a net current of 0, i.e., current balance within a coil is achieved. Therefore, when the control module 90 obtains that the total current of the first live branch 41 and the first neutral branch 45 is less than or equal to the predetermined threshold, no current leakage occurs, or a current leaked from the shell 20 does not exceed a current tolerable by the human body, posing no risk of electric shock. The control module 90 is configured to control the first switch element K1 to remain in a switching-on state and the inverter 76 to maintain a current operation state, to output electric energy from the battery module 50 to the load 200, until charging of the load 200 is completed.

In one embodiment, in a case where no utility power is input and the second switch element K2 is in the switching-on state, when unsatisfactory contact occurs between a live wire of the load 200 and the shell 20 and results in a current leakage, a current may flow along a path sequentially formed by the shell 20, the human body, and the shell 20 if two parts of the human body (such as both hands as illustrated in the figure) touch the shell 20 simultaneously, posing the risk of electric shock. In this case, a current flowing path is sequentially formed by the fourth live terminal L4, the shell 20, the first ground terminal PE1, the current limiter 721, and the first neutral terminal N1. A part of the current in the live wire may return to the first neutral terminal N1 through the shell 20, in which case a net current after the current in the first live branch 41 and the current in the first neutral branch 45 cancel each other out is greater than 0. Therefore, when the control module 90 obtains that the total current of the first live branch 41 and the first neutral branch 45 is greater than the predetermined threshold, the current leaked from the shell 20 exceeds the current tolerable by the human body, posing the risk of electric shock. In one embodiment, the control module 90 is configured to control, subsequent to determining that the risk of electric shock exists, the first switch element K1 to be switched off to cut off the current outputted from the first live branch 41 and the first neutral branch 45 to the load, and the inverter 76 to stop outputting the electric energy from the battery module 50. In one embodiment, the control module 90 is configured to control, subsequent to determining that the risk of electric shock exists, the first switch element K1 to be switched off to cut off the current outputted from the first live branch 41 and the first neutral branch 45 to the load. In one embodiment, the control module 90 is configured to control, subsequent to determining that the risk of electric shock exists, the inverter 76 to stop outputting the electric energy from the battery module 50. Therefore, the risk of electric shock can be avoided, and reliability of the energy storage power supply 100 can be improved to a certain extent, ensuring user safety.

It should be understood that the predetermined threshold may be specifically defined based on a safe current for preventing human electric shock, and the present disclosure is not limited in this regard.

In some embodiments, the grounding unit 72 includes the second switch element K2 and the current limiter 721 that are connected in series between the first neutral terminal N1 and the first ground terminal PE1. The current limiter 721 is configured to simulate a grounding impedance. When the second switch element K2 is switched on, the current limiter 721 is connected between the first neutral terminal N1 and the first ground terminal PE1 to support the grounding detection. When the second switch element K2 is switched off, the current limiter 721 is disconnected from the first neutral terminal N1 and the first ground terminal PE1.

In this way, power can be supplied from the energy storage power supply 100 to the load 200 through passing the grounding detection of the load 200.

In an exemplary embodiment of the present disclosure, when the second switch element K2 is in the switching-on state, a detection object for a grounding detection module inside the load 200 is converted from a voltage difference between the first live terminal L1 and the first ground terminal PE1 to a voltage difference between the first neutral terminal N1 and the first ground terminal PE1. Since the current limiter 721 is connected between the first neutral terminal N1 and the first ground terminal PE1, a voltage difference similar to that between the first live terminal L1 and the first ground terminal PE1 under normal grounding is formed between the first neutral terminal N1 and the first ground terminal PE1, providing the grounding signal to the load 200, and passing the grounding detection of the load 200. In this way, the energy storage power supply 100 can normally supply power to the load 200, to ensure a normal operation of the load 200 in an independent power supply state of the energy storage power supply 100, improving compatibility of the energy storage power supply 100 and user experience.

In an exemplary embodiment of the present disclosure, the second switch element K2 may include a relay, and the current limiter 721 may include, but is not limited to, a resistor, a resistor-capacitor combination, or a combination thereof.

In some embodiments, the power supply circuit 100a further includes an alternating-current input interface 32 configured to be connected to a utility power. The alternating-current input interface 32 includes a third live terminal L3, a third neutral terminal N3, and a second ground terminal PE2. The first live terminal L1 and the third live terminal L3 are connected to each other by a second live branch 43. The first neutral terminal N1 and the third neutral terminal N3 are connected to each other by a second neutral branch 47. The firs ground terminal PE1 and the second ground terminal PE2 are connected to each other by a ground branch. The grounding unit 72 is connected to the second neutral branch 47 and the first ground terminal PE1.

In this way, electric energy supply under different operation conditions can be achieved.

In an exemplary embodiment of the present disclosure, the alternating-current input interface 32 is disposed on the housing 10 of the energy storage power supply 100 to facilitate a connection with the external device. The alternating-current input interface 32 may be pluggably connected to the utility power through a cable. In an exemplary embodiment of the present disclosure, the alternating-current input interface 32 may be a male interface or a female interface. In one embodiment, the control module 90 is configured to control, when the utility power input is detected by energy storage power supply 100, the first switch K1 to be switched on and the second switch K2 to be switched off. Electric energy from the utility power may be input into the energy storage power supply 100 through the alternating-current input interface 32 to supply power to the battery module 50, and/or may be input into the load 200 through the alternating-current input interface 32 and the alternating-current output interface 34 to supply power to the load. In one embodiment, the control module 90 is configured to control, when no utility power input is detected by the energy storage power supply 100, the first switch K1 and the second switch K2 to be switched on. In this way, the energy storage power supply 100 can independently supply power to the load 200.

In some embodiments, as illustrated in FIG. 1, the power supply circuit 100a includes a third switch element K3 and a fourth switch element K4. The third switch element K3 is disposed on the second live branch 43. The fourth switch element K4 is disposed on the second neutral branch 47. The grounding unit 72 includes a first connection terminal P1 and a second connection terminal P2. The first connection terminal P1 is connected between the third neutral terminal N3 and the fourth switch element K4. The second connection terminal P2 is connected to the second ground terminal PE2, the first ground terminal PE1, or the ground branch.

In this way, by controlling switching-on and switching-off of different switch elements, connection and disconnection of different branches are easily achieved.

In an exemplary embodiment of the present disclosure, as illustrated in FIG. 1, the third switch element K3 is disposed on the second live branch 43. That is, the third switch element K3 is connected between the third live terminal L3 and the first live terminal L1. Therefore, the control module 90 may control switching-on and switching-off of the third switch element K3, controlling connection and disconnection of the second live branch 43.

The fourth switch element K4 is disposed on the second neutral branch 47. That is, the fourth switch element K4 is connected between the third neutral terminal N3 and the first neutral terminal N1. Therefore, the control module 90 may control switching-on and switching-off of the fourth switch element K4, controlling connection and disconnection of the second neutral branch 47.

The first switch element K1 is disposed on the first live branch 41 and the first neutral branch 45. Therefore, the control module 90 may control switching-on and switching-off of the first switch element K1, controlling connection and disconnection of the first live branch 41 and the first neutral branch 45.

The first connection terminal P1 of the grounding unit 72 is connected between the third neutral terminal N3 and the fourth switch element K4, and the second connection terminal P2 of the grounding unit 72 is connected to the second ground terminal PE2, the first ground terminal PE1, or the ground branch. Therefore, the control module 90 may control switching-on and switching-off of the second switch element K2, controlling whether the current limiter 721 is connected to or disconnected from the ground branch.

In an exemplary embodiment of the present disclosure, each of the third switch element K3 and the fourth switch element K4 may include a relay.

In some embodiments, as illustrated in FIG. 1, the control module 90 is configured to control, when the energy storage power supply 100 is disconnected from the utility power and the load 200 requires grounding, each of the first switch element K1, the second switch element K2, and the fourth switch element K4 to be switched on and the third switch element K3 to be switched off, enabling electric energy output by the inverter 76 to be transmitted to the load 200.

In this way, through cooperation of the first switch element K1, the second switch element K2, the third switch element K3, and the fourth switch element K4, independent power supply from the energy storage power supply 100 to the load 200 is easily achieved.

In an exemplary embodiment of the present disclosure, the control module 90 is electrically connected to the second switch element K2, the first switch element K1, the third switch element K3, and the fourth switch element K4. As illustrated in FIG. 1, in one embodiment, the control module 90 is configured to control, when the energy storage power supply 100 is disconnected from the utility power and the load 200 requires grounding, the third switch element K3 to be switched off, enabling the disconnection of the second live branch 43. The control module 90 is further configured to: control the fourth switch element K4 to be switched on to enable the connection of the second neutral branch 47; control the first switch element K1 to be switched on to enable the connection of the first live branch 41 and the connection of the first neutral branch 45; and control the second switch element K2 to be switched on to enable connection of a line between the second neutral terminal N2 and the first ground terminal PE1. The current limiter 721 is connected to the ground branch to provide the grounding signal to the load 200. Therefore, the grounding detection module of the load 200 can detect the grounding signal, to pass the grounding detection. The control module 90 is capable of controlling the inverter 76 to convert the direct current output by the battery module 50 into the alternating current suitable for supplying power to the load 200 and to output the alternating current to the alternating-current output interface 34, which is then input to the load 200 to charge the load 200.

In some embodiments, as illustrated in FIG. 1, the control module 90 is configured to control, when the energy storage power supply 100 is connected to the utility power, each of the first switch element K1, the third switch element K3, and the fourth switch element K4 to be switched on and the second switch element K2 to be switched off, enabling electric energy from the utility power to be transmitted to the load 200.

In this way, through the cooperation of the first switch element K1, the second switch element K2, the third switch element K3, and the fourth switch element K4, supplying power from the utility power to the load 200 through the energy storage power supply 100 is easily achieved.

In an exemplary embodiment of the present disclosure, as illustrated in FIG. 1, the control module 90 is configured to: when the utility power input is detected by the energy storage power supply 100, control the third switch element K3 to be switched on to enable the connection of the second live branch 43, control the fourth switch element K4 to be switched on to enable the connection of the second neutral branch 47, and control the first switch element K1 to be switched on to enable the connection of the first live branch 41 and connection of a line between the first live branch 41 and the first neutral branch 45. The control module 90 is further configured to control the second switch element K2 to be switched off to enable disconnection of the line between the second neutral terminal N2 and the first ground terminal PE1. The current limiter 721 is not connected between the second neutral terminal N2 and the first ground terminal PE1 and thus unable to provide the grounding signal. Therefore, a ground wire of the utility power may be connected to the first ground terminal PE1 through the second ground terminal PE2 and the ground branch, and the ground terminal of the load 200 is connected to the first ground terminal PE1. In this way, the utility power provides a grounding function for the load 200, such that the grounding detection module of the load 200 can detect the grounding signal and pass the grounding detection. The alternating current output by the utility power is transmitted to the alternating-current output interface 34 through the alternating-current input interface 32, and is then output to the load 200 to supply power to the load 200.

It should be understood that, in a case where the battery module 50 of the energy storage power supply 100 has a charging demand, while the utility power supplies power to the load 200, the control module 90 may control the inverter 76 to convert the alternating current input from the alternating-current input interface 32 into the direct current suitable for supplying power to the battery module 50, charging the battery module 50.

In some embodiments, as illustrated in FIG. 2, the power supply circuit 100a includes a third switch element K3 and a fourth switch element K4. The third switch element K3 is disposed on the second live branch 43 and the second neutral branch 47. The fourth switch element K4 is disposed on the second neutral branch 47 and located between the third switch element K3 and the first neutral terminal N1. The grounding unit 72 includes a first connection terminal P1 and a second connection terminal P2. The first connection terminal P1 is connected between the third switch element K3 and the fourth switch element K4. The second connection terminal P2 is connected to the second ground terminal PE2, the first ground terminal PE1, or the ground branch.

In this way, by controlling switching-on and switching-off of different switch elements, connection and disconnection of different branches are easily achieved.

In an exemplary embodiment of the present disclosure, as illustrated in FIG. 2, the third switch element K3 is disposed on the second live branch 43. That is, the third switch element K3 is connected between the third live terminal L3 and the first live terminal L1. Also, the third switch element K3 is disposed on the third neutral branch. That is, the third switch element K3 is connected between the third neutral terminal N3 and the first connection terminal P1. Therefore, the control module 90 may control the switching-on and switching-off of the third switch element K3, controlling connection and disconnection of a line between the third live terminal L3 and the first live terminal L1 and connection and disconnection of a line between the third neutral terminal N3 and the first connection terminal P1.

The fourth switch element K4 is disposed on the second neutral branch 47. That is, the fourth switch element K4 is connected between the first connection terminal P1 and the first neutral terminal N1. Therefore, the control module 90 may control switching-on and switching-off of the fourth switch element K4, controlling connection and disconnection of a line between the first connection terminal P1 and the first neutral terminal N1.

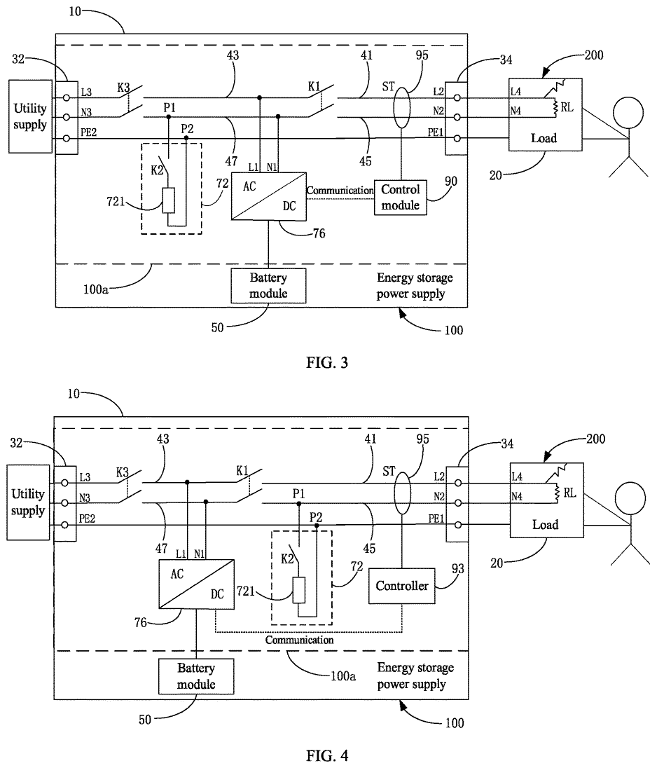

The number of the fourth switch elements K4 may be specifically determined as desired, which is not specifically limited in the present disclosure. It should be understood that, in some embodiments, a plurality of fourth switch elements K4 may be provided and sequentially connected in series between the first connection terminal P1 and the first neutral terminal N1. In some embodiments, as illustrated in FIG. 3 and FIG. 4, the fourth switch element K4 may be omitted.

The first switch element K1 is disposed on the first live branch 41 and the first neutral branch 45. Therefore, the control module 90 may control the switching-on and switching-off of the first switch element K1, controlling the connection and disconnection of the first live branch 41 and the first neutral branch 45.

In the embodiments of FIG. 2 and FIG. 3, the first connection terminal P1 of the grounding unit 72 is connected between the third switch element K3 and the first neutral terminal N1. In the embodiment of FIG. 4, the first connection terminal P1 is connected between the first switch element K1 and the second neutral terminal N2. The second connection terminal P2 is connected to the second ground terminal PE2, the first ground terminal PE1, or the ground branch. Therefore, the control module 90 may control the switching-on and switching-off of the second switch element K2, controlling whether the current limiter 721 is connected to or disconnected from the ground branch.

In some embodiments, as illustrated in FIG. 2, the control module 90 is configured to control, when the energy storage power supply 100 is disconnected from the utility power and the load 200 requires grounding, each of the first switch element K1, the second switch element K2, and the fourth switch element K4 to be switched on and the third switch element K3 to be switched off, enabling electric energy output by the inverter 76 to be transmitted to the load 200.

In this way, through the cooperation of the first switch element K1, the second switch element K2, the third switch element K3, and the fourth switch element K4, the independent power supply from the energy storage power supply 100 to the load 200 is easily achieved.

In an exemplary embodiment of the present disclosure, the control module 90 is electrically connected to the first switch element K1, the second switch element K2, the third switch element K3, and the fourth switch element K4. In the embodiment illustrated in FIG. 2, the control module 90 is configured to: when the energy storage power supply 100 is disconnected from the utility power and the load 200 requires grounding, control the third switch element K3 to be switched off to enable the disconnection of the second live branch 43, and control the line between the third neutral terminal N3 and the first connection terminal P1 to be disconnected. The control module 90 is further configured to: control the fourth switch element K4 to be switched on to enable the connection of the line between the first connection terminal P1 and the first neutral terminal N1, control the first switch element K1 to be switched on to enable the connection of the first live branch 41 and the connection of the first neutral branch 45, and control the second switch element K2 to be switched on to enable connection of the ground branch. The current limiter 721 is connected to the ground branch to provide the grounding signal to the load 200. Therefore, the grounding detection module of the load 200 can detect the grounding signal, to pass the grounding detection. The control module 90 can control the inverter 76 to convert the direct current output by the battery module 50 into the alternating current suitable for supplying power to the load 200 and to output the alternating current to the alternating-current output interface 34, which is then input to the load 200 to charge the load 200.

In the embodiments illustrated in FIG. 3 and FIG. 4, the control module 90 is configured to: when the energy storage power supply 100 is disconnected from the utility power and the load 200 requires grounding, control the third switch element K3 to be switched off, enabling the disconnection of the second live branch 43, and control a line between the second neutral terminal N2 and the first connection terminal P1 to be disconnected. The control module 90 is further configured to: control the first switch element K1 to be switched on to enable the connection of the first live branch 41 and the connection of the first neutral branch 45, and control the second switch element K2 to be switched on to enable connection of a line between the third switch element K3 and the first ground terminal PE1. The current limiter 721 is connected to the ground branch to provide the grounding signal to the load 200. The electric energy output by the inverter 76 is transmitted to the load 200.

In some embodiments, as illustrated in FIG. 2, the control module 90 is configured to control, when the energy storage power supply 100 is connected to the utility power, each of the first switch element K1, the third switch element K3, and the fourth switch element K4 to be switched on and the second switch element K2 to be switched off, enabling electric energy from the utility power to be transmitted to the load 200.

In this way, through the cooperation of the first switch element K1, the second switch element K2, the third switch element K3, and the fourth switch element K4, supplying power from the utility power to the load 200 through the energy storage power supply 100 is easily achieved.

In an exemplary embodiment of the present disclosure, as illustrated in FIG. 2, the control module 90 is configured to: when the utility power input is detected by the energy storage power supply 100, control the third switch element K3 to be switched on to enable the connection of the second live branch 43 and the connection of the second neutral branch 47, control the fourth switch element K4 to be switched on to enable the connection of the l ine between the first connection terminal P1 and the first neutral terminal N1, and control the first switch element K1 to be switched on to enable the connection of the first live branch 41 and the connection of the first neutral branch 45. The control module 90 is further configured to control the second switch element K2 to be switched off to enable disconnection of the line between the third switch element K3 and the first ground terminal PE1. The current limiter 721 is disconnected from the ground branch and thus unable to provide the grounding signal. Therefore, the ground wire of the utility power is connected to the first ground terminal PE1 through the second ground terminal PE2, and the ground terminal of the load 200 is connected to the first ground terminal PE1. In this way, the grounding detection module of the load 200 can detect the grounding signal, to pass the grounding detection. The alternating current output by the utility power is transmitted to the alternating-current output interface 34 through the alternating-current input interface 32, and is then output to the load 200 to supply power to the load 200.

In an exemplary embodiment of the present disclosure, as illustrated in FIG. 3 and FIG. 4, the control module 90 is configured to, when the utility power input is detected by the energy storage power supply 100, control the third switch element K3 to be switched on to enable the connection of the second live branch 43 and the connection of the second neutral branch 47, and control the first switch element K1 to be switched on to enable the connection of the first live branch 41 and the connection of the first neutral branch 45. The control module 90 is further configured to control the second switch element K2 to be switched off to enable disconnection of a line between the first switch element K1 and the first ground terminal PE1. The current limiter 721 is disconnected from the ground branch and thus unable to provide the grounding signal. Therefore, the utility power can provide the grounding signal to the load, to pass the grounding detection. The alternating current output by the utility power may be output to the load 200 through the energy storage power supply 100 to supply power to the load 200.

It should be understood that, in the case where the battery module 50 of the energy storage power supply 100 has the charging demand, while the utility power supplies power to the load 200, the control module 90 may control the bidirectional alternating-current/direct-current conversion module 76 to convert the alternating current input from the alternating-current input interface 32 into the direct current suitable for supplying power to the battery module 50, charging the battery module 50.

As illustrated in FIG. 1 to FIG. 3, an embodiment of the present disclosure provides the energy storage power supply 100. The energy storage power supply 100 includes the power supply circuit 100a according to any of the above embodiments and a battery module 50 electrically connected to the inverter 76.

In an exemplary embodiment of the present disclosure, the energy storage power supply 100 includes the housing 10. Both the power supply circuit 100a and the battery module 50 are located in the housing 10 to be protected by the housing 10. The housing 10 is a component configured to protect other components of the energy storage power supply 100, and can prevent moisture, dust, and the like from intruding into electrified components, which would result in short circuits, or prevent corrosion leading to open circuits and other problems. The housing 10 is made of a material including, but not limited to, plastic, metal (such as iron, aluminum, and an aluminum alloy), or the like. A shape of the housing 10 includes, but is not limited to, a rectangular parallelepiped, a cylinder, or the like.

The battery module 50 is a component configured to store and output the electric energy. The battery module 50 may include one or a plurality of battery cells. The plurality of battery cells may be connected in series, in parallel, or in series-parallel. That “in series-parallel” refers to that the plurality of battery cells are connected both in series and in parallel. The battery cell may include, but is not limited to, a lithium battery, a sodium battery, or the like. The inverter 76 is electrically connected to both the battery module 50 and the control module 90. In one embodiment, the control module 90 is configured to control, when the utility power input is detected by the energy storage power supply 100 and the battery module 50 needs to be charged, the inverter 76 to convert the alternating current output by the utility power into the direct current suitable for supplying power to the battery module 50. In one embodiment, the control module 90 is configured to control, when no utility power input is detected by the energy storage power supply 100 and the load 200 needs to be charged, the inverter 76 to convert the direct current output by the battery module 50 into the alternating current suitable for supplying power to the load 200.

It should be noted that the above explanations and descriptions regarding the embodiments and advantageous effects of the power supply circuit 100a are also applicable to the energy storage power supply 100 according to this embodiment. To avoid redundancy, detailed description thereof is omitted here.

Reference throughout this specification to terms such as “an embodiment”, “several embodiments”, “illustrative embodiments”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples.

Although the embodiments of the present disclosure have been shown and described above, it should be understood that the above-mentioned embodiments are exemplary and should not be construed as limiting the present disclosure. Those of ordinary skill in the art can make changes, modifications, substitutions, and alternations to the above-mentioned embodiments within the scope of the present disclosure.

What is claimed is:

1. A power supply circuit for an energy storage power supply, the power supply circuit comprising:
an inverter comprising a first live terminal and a first neutral terminal;
an alternating-current output interface comprising a second live terminal, a second neutral terminal, and a first ground terminal, the alternating-current output interface being configured to be connected to a load;
a first live branch, the first live terminal and the second live terminal being connected to each other by the first live branch;
a first neutral branch, the first neutral terminal and the second neutral terminal being connected to each other by the first neutral branch;
a detection module configured to detect a current flowing through the first live branch and a current flowing through the first neutral branch;
a grounding unit configured to electrically connect the first neutral terminal and the first ground terminal through bypassing the detection module, to support a grounding detection;
a first switch element configured to control connection and disconnection of the first live branch and the first neutral branch; and
a control module configured to control, when a total current of the first live branch and the first neutral branch is greater than a predetermined threshold, the first switch element to be switched off and/or the inverter to stop operating.

2. The power supply circuit according to claim 1, wherein the grounding unit comprises a second switch element and a current limiter that are connected in series between the first neutral terminal and the first ground terminal, wherein:
the current limiter is configured to simulate a grounding impedance; and
the second switch element is configured to: when being switched on, connect the current limiter to the first neutral terminal and the first ground terminal to support the grounding detection; and when being switched off, disconnect the current limiter from the first neutral terminal and the first ground terminal.

3. The power supply circuit according to claim 2, further comprising an alternating-current input interface configured to be connected to a utility power, the alternating-current input interface comprising a third live terminal, a third neutral terminal, and a second ground terminal, wherein:
the first live terminal and the third live terminal are connected to each other by a second live branch;
the first neutral terminal and the third neutral terminal are connected to each other by a second neutral branch;
the first ground terminal and the second ground terminal are connected to each other by a ground branch; and
the grounding unit is electrically connected to the second neutral branch and the first ground terminal.

4. The power supply circuit according to claim 3, further comprising:
a third switch element disposed on the second live branch; and
a fourth switch element disposed on the second neutral branch, wherein:
the grounding unit comprises a first connection terminal and a second connection terminal, the first connection terminal being connected between the third neutral terminal and the fourth switch element, and the second connection terminal being connected to the second ground terminal, the first ground terminal, or the ground branch.

5. The power supply circuit according to claim 4, wherein the control module is further configured to:
control, when the alternating-current input interface is disconnected from the utility power and the load requires grounding, each of the first switch element, the second switch element, and the fourth switch element to be switched on and the third switch element to be switched off, enabling electric energy output by the inverter to be transmitted to the load.

6. The power supply circuit according to claim 4, wherein the control module is further configured to control, when the alternating-current input interface is connected to the utility power, each of the first switch element, the third switch element, and the fourth switch element to be switched on and the second switch element to be switched off, enabling electric energy from the utility power to be transmitted to the load.

7. The power supply circuit according to claim 3, further comprising:
a third switch element disposed on the second live branch and the second neutral branch; and
a fourth switch element disposed on the second neutral branch and located between the third switch element and the first neutral terminal, wherein:
the grounding unit comprises a first connection terminal and a second connection terminal, the first connection terminal being connected between the third switch element and the fourth switch element, and the second connection terminal being connected to the second ground terminal, the first ground terminal, or the ground branch.

8. The power supply circuit according to claim 7, wherein the control module is further configured to control, when the alternating-current input interface is disconnected from the utility power and the load requires grounding, each of the first switch element, the second switch element, and the fourth switch element to be switched on and the third switch element to be switched off, enabling electric energy output by the inverter to be transmitted to the load.

9. The power supply circuit according to claim 7, wherein the control module is further configured to control, when the alternating-current input interface is connected to the utility power, each of the first switch element, the third switch element, and the fourth switch element to be switched on and the second switch element to be switched off, enabling electric energy from the utility power to be transmitted to the load.

10. The power supply circuit according to claim 3, further comprising a third switch element disposed on the second live branch and the second neutral branch, wherein:
the grounding unit comprises a first connection terminal and a second connection terminal, the first connection terminal being connected between the third switch element and the first neutral terminal, and the second connection terminal being connected to the second ground terminal, the first ground terminal, or the ground branch.

11. The power supply circuit according to claim 3, further comprising a third switch element disposed on the second live branch and the second neutral branch, wherein:
the grounding unit comprises a first connection terminal and a second connection terminal, the first connection terminal being connected between the first switch element and the second neutral terminal, and the second connection terminal being connected to the second ground terminal, the first ground terminal, or the ground branch.

12. An energy storage power supply, comprising:
the power supply circuit according to claim 1; and
a battery module electrically connected to the inverter.

13. The energy storage power supply according to claim 12, wherein the grounding unit comprises a second switch element and a current limiter that are connected in series between the first neutral terminal and the first ground terminal, wherein:
the current limiter is configured to simulate a grounding impedance; and
the second switch element is configured to: when being switched on, connect the current limiter to the first neutral terminal and the first ground terminal to support the grounding detection; and when being switched off, disconnect the current limiter from the first neutral terminal and the first ground terminal.

14. The energy storage power supply according to claim 13, wherein the power supply circuit further comprises an alternating-current input interface configured to be connected to a utility power, the alternating-current input interface comprising a third live terminal, a third neutral terminal, and a second ground terminal, wherein:
the first live terminal and the third live terminal are connected to each other by a second live branch;
the first neutral terminal and the third neutral terminal are connected to each other by a second neutral branch;
the first ground terminal and the second ground terminal are connected to each other by a ground branch; and
the grounding unit is electrically connected to the second neutral branch and the first ground terminal.

15. The energy storage power supply according to claim 14, wherein the power supply circuit further comprises:
a third switch element disposed on the second live branch; and
a fourth switch element disposed on the second neutral branch, wherein:
the grounding unit comprises a first connection terminal and a second connection terminal, the first connection terminal being connected between the third neutral terminal and the fourth switch element, and the second connection terminal being connected to the second ground terminal, the first ground terminal, or the ground branch.

16. The energy storage power supply according to claim 15, wherein the control module is further configured to:
control, when the alternating-current input interface is disconnected from the utility power and the load requires grounding, each of the first switch element, the second switch element, and the fourth switch element to be switched on and the third switch element to be switched off, enabling electric energy output by the inverter to be transmitted to the load.

17. The energy storage power supply according to claim 15, wherein the control module is further configured to control, when the alternating-current input interface is connected to the utility power, each of the first switch element, the third switch element, and the fourth switch element to be switched on and the second switch element to be switched off, enabling electric energy from the utility power to be transmitted to the load.

18. The energy storage power supply according to claim 14, wherein the power supply circuit further comprises:
a third switch element disposed on the second live branch and the second neutral branch; and
a fourth switch element disposed on the second neutral branch and located between the third switch element and the first neutral terminal, wherein:
the grounding unit comprises a first connection terminal and a second connection terminal, the first connection terminal being connected between the third switch element and the fourth switch element, and the second connection terminal being connected to the second ground terminal, the first ground terminal, or the ground branch.

19. The energy storage power supply according to claim 18, wherein the control module is further configured to control, when the alternating-current input interface is disconnected from the utility power and the load requires grounding, each of the first switch element, the second switch element, and the fourth switch element to be switched on and the third switch element to be switched off, enabling electric energy output by the inverter to be transmitted to the load.

20. The energy storage power supply according to claim 18, wherein the control module is further configured to control, when the alternating-current input interface is connected to the utility power, each of the first switch element, the third switch element, and the fourth switch element to be switched on and the second switch element to be switched off, enabling electric energy from the utility power to be transmitted to the load.
